(19) United States
(12) Patent Application Publication
(10) Pub. No.: US 2016/0211094 A1
(43) Pub. Date: Jul. 21, 2016

(54) SWITCH DEVICE AND MOTOR VEHICLE

(71) Applicant: GM GLOBAL TECHNOLOGY OPERATIONS LLC, Detroit, MI (US)

(72) Inventors: Michael FUCHS, Alzey-Weinheim (DE); Friedrich HEIN, Mainz (DE)

(73) Assignee: GM GLOBAL TECHNOLOGY OPERATIONS LLC, Detroit, MI (US)

(21) Appl. No.: 14/995,580

(22) Filed: Jan. 14, 2016

(30) Foreign Application Priority Data
Jan. 15, 2015 (DE) 102015000465.4

(51) Int. Cl. H01H 13/06

(52) U.S. Cl. CPC H01H 13/06; H01H 2223/002; H01H 2231/026

(57) ABSTRACT

A switch device for a panel element of a motor vehicle includes a first housing part arranged in or on the panel element. A second housing part, which is preferably disk-shaped or plate-shaped, is movable relative to the first housing part, particularly rotatable about a rotational axis. A switching element is arranged in a hollow space formed between the first and second housing parts and either directly or indirectly abuts on the first housing part. The switching element can be actuated due to the motion of the second housing part relative to the first housing part along an actuating direction. A sealing device features a first seal extensively overlapping the switching element transverse and/or oblique to the actuating direction at least on the side facing away from the first housing part.

### CROSS-REFERENCE TO RELATED APPLICATION

This application claims priority to German Patent Application No. 102015000465.4, filed Jan. 15, 2015, which is incorporated herein by reference in its entirety.

### TECHNICAL FIELD

The present disclosure pertains to a switch device for a panel element such as a door, a hatch or a window, particularly for a motor vehicle, as well as to a motor vehicle with such a switch device.

### BACKGROUND

DE 10 2011 008 989 A1 discloses a switch device, in which a switching element is arranged between a first housing part and a second housing part and can be actuated due to a relative motion between the first housing part and the second housing part. In order to prevent the admission of dirt and moisture, a seal is provided between the first housing part and the second housing part in the known switch device.

### SUMMARY

In accordance with the present disclosure a switch device is provided, in which the risk of admitting dirt or moisture to the switching element is additionally reduced. The switch device is configured for a panel element such as a door, a hatch or a window, particularly for a motor vehicle and includes at least one first housing part that is or can be arranged in or on the panel element, with at least one disk-shaped or plate-shaped second housing part, which is fixed such that it is movable relative to the first housing part, particularly rotatable about a rotational axis. At least one switching element is arranged in a hollow space formed between the first housing part and the second housing part and either directly or indirectly abuts extensively on the first housing part with one side. The switching element can be actuated due to the motion of the second housing part relative to the first housing part along an actuating direction. At least one sealing device includes at least one first extensive seal that extensively overlaps the switching element transverse or oblique to the actuating direction on the side facing away from the first housing part.

The panel element may include, e.g., a vehicle door or a hatch such as a tailgate. It would furthermore be conceivable that the panel element includes a window of the motor vehicle.

The second housing part may include, e.g., a vehicle emblem or a vehicle logo that can be accessed and actuated from outside. The first housing part and the second housing part may include a plastic.

The switching element is at least almost entirely surrounded by the first housing part and the second housing part due to the fact that the switch device includes at least one sealing device featuring at least one first sealing element that extensively overlaps the switching element on the side facing away from the first housing part, i.e. on the free side.

In order to allow an actuation of the switching element by moving the second housing part relative to the first housing part, it is advantageous if the first sealing element is realized such that it can be flexibly bent and/or stretched at least in the actuating direction of the switching element and/or if the first sealing element is arranged in the hollow space such that it overlaps this hollow space transverse or oblique to the actuating direction.

The switching element can be actuated by moving the second housing part relative to the first housing part due to the fact that the first sealing element can be flexibly bent and/or stretched. In this case, the first sealing element forms at least part of a resetting element that at least partially resets the second housing part into the non-actuated home position after an actuation of the switching element.

It is furthermore advantageous if the first sealing element is spaced apart from the switching element or abuts on the switching element, particularly such that it is fixed thereon, and/or if the first sealing element is separably or inseparably fixed on the switching element, particularly by means of bonding.

In order to ensure an automatic reset of the second housing part after an actuation, it is advantageous if the switch device includes at least one resetting element, wherein the at least one resetting element includes at least one leaf spring that is positioned between the switching element and the second housing part or the first sealing element and can be arranged, in particular, in a corresponding recess in the first housing part.

The design of the resetting element may be flexibly incorporated into the switch device. For example, the switching element may form part of the resetting element due to its flexibly bendable and/or stretchable design. It is furthermore advantageous if the at least one resetting element includes at least one leaf spring that is positioned between the switching element and the second housing part or the first sealing element and can be arranged, in particular, in a corresponding recess in the first housing part.

In order to prevent the admission of dirt or moisture between the first housing part and the second housing part, it is advantageous if the switch device includes at least one second sealing element that is peripherally arranged between the panel element and the outer edge of the first housing part and/or if the switch device includes at least one third sealing element that is peripherally arranged between the first housing part and the outer edge of the second housing part.

The second sealing element and/or the third sealing element may include any material as long as the function of preventing the admission of dirt or moisture is ensured. In this context, it is particularly advantageous if the second sealing element and/or the third sealing element is designed in a frame-like fashion, particularly such that it respectively corresponds to the outer contour of the first housing part or the second housing part, and/or if the second sealing element and/or the third sealing element includes a plastic or a foam.

In order to easily connect the second housing part to the first housing part, a fixing unit formed between the first housing part and the second housing part is provided in one embodiment of the switch device and makes it possible to movably, in particular rotatably, fix the second housing part on the first housing part. The fixing unit includes at least one socket-like receptacle on the first housing part and at least one pin, which is designed corresponding, in particular complementary, to the at least one socket-like receptacle, on the second housing part, and wherein the pin can be clipped into the socket-like receptacle.

The fixing unit can be designed in a particularly simple and inexpensive fashion if the switch device includes at least two socket-like receptacles and at least two pins. The fixing unit is designed in a hinge-like fashion and includes the rotational axis.

In order to ensure an actuation of the switching element with a reduced expenditure of force, it is advantageous if the rotational axis essentially extends transverse to the actuating direction and/or if the fixing unit including the rotational axis is spaced apart from the switching element transverse to the actuating direction. Since the rotational axis is spaced apart from the switching element, the forces required for actuating the switching element are reduced.

In order to prevent the first housing part from inadvertently tilting during its transfer from a non-actuated home position into an actuated position, in which the switching element is activated, it is advantageous if the switch device includes at least one guide unit that is formed between the first housing part and the second housing part and includes, in particular, a recess in the first housing part and a projection, which extends in the actuating direction and features a wedge-shaped section, on the second housing part. The projection slides into the recess during the actuation in the actuating direction and its motion opposite to the actuating direction is restricted by the wedge-shaped section that engages behind the recess in the non-actuated home position.

It would basically be conceivable that the first housing part, the at least one socket-like receptacle and the recess of the guide unit are formed by individual components. With respect to the ease of assembly and the cost-effectiveness, however, it is advantageous if the first housing part, the at least one socket-like receptacle and the recess of the guide unit include a common component, particularly an injection-molded part.

The switching element may basically include any electric switching element. In one embodiment of the switch device, it is proposed that the at least one switching element includes a microswitch.

It is furthermore advantageous with respect to the ease of assembly and the cost-effectiveness if the switch device includes at least one electric contact. The electric contact can be arranged on the first housing part on the opposite side of the switching element and the switching element can be fixed on or in the electric contact such that an electrical connection is produced.

The present disclosure may be included as part of a motor vehicle that features at least one switch device, particularly a switch device with at least one of the above-described characteristics.

The switch device and the motor vehicle are advantageous in several respects. Since the switch device includes a switching element that is extensively overlapped by a first extensive seal, the admission of dirt or moisture to the contacting element is prevented. The risk of admitting dirt or moisture to the switching element is additionally lowered if a second sealing element and a third sealing element are respectively arranged between the first housing part and the panel element and between the first housing part and the second housing part. Since the rotational axis, about which the second housing part is rotatable during the actuation, is spaced apart from the switching element, the actuating forces required for the actuation are reduced.

### BRIEF DESCRIPTION OF THE DRAWINGS

The present disclosure will hereinafter be described in conjunction with the following drawing figures, wherein like numerals denote like elements.

FIG. 1 shows a perspective exploded view of an embodiment of the switch device;

FIG. 2 shows a sectioned side view of the switch device according to FIG. 1 in a non-actuated home position;

FIG. 3 shows a sectioned side view of the switch device according to FIG. 1 in an actuated position; and

FIG. 4 shows a section through a pin of the fixing unit along the actuating direction of the switch device according to FIG. 1.

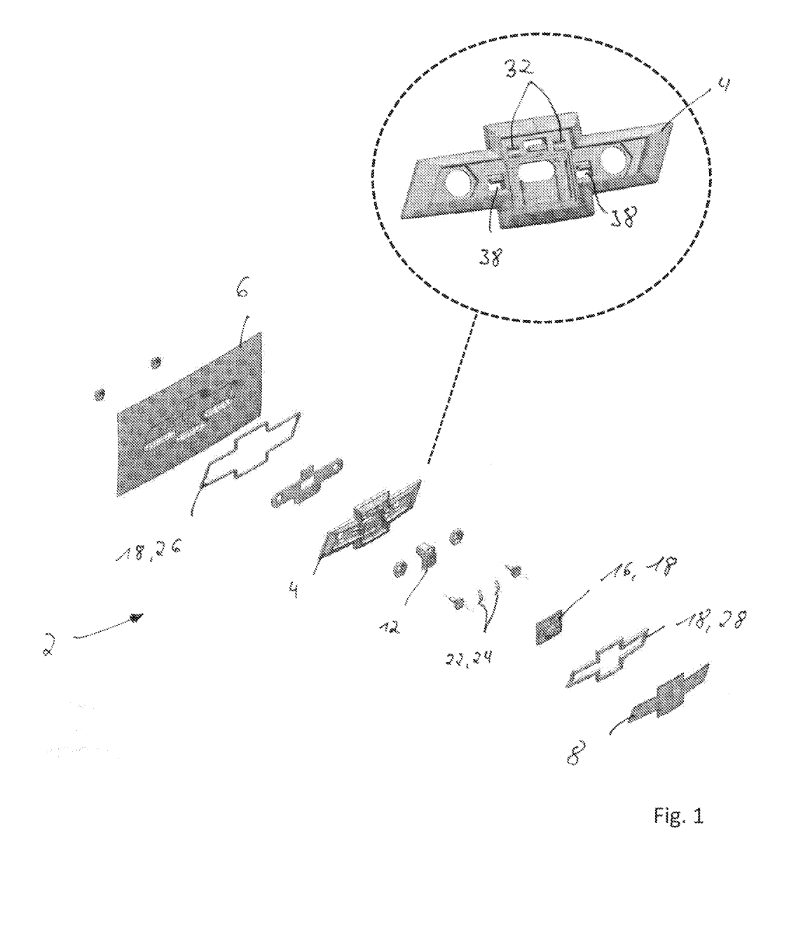

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The figures show a switch device for a panel element 6 such as a door, a hatch or a window, particularly of a motor vehicle, which is altogether identified by the reference symbol 2. The switch device includes a first housing part 4 that can be arranged on the panel element 6. A second housing part 8 is fixed on the first housing part 4 such that it is movable relative to the first housing part 4, preferably rotatable about a rotational axis 10.

A switching element 12 is fixed between the second housing part 8 and the first housing part 4 and arranged in a hollow space 14 formed between the first housing part 4 and the second housing part 8. The switch device 2 includes a first sealing element 16 of a sealing device 18 on the side of the switching element 12 facing away from the first housing part 4. The sealing device 18 extensively overlaps the switching element 12 transverse or oblique to an actuating direction 20 at least on the side facing away from the first housing part 4. The first sealing element 16 of the sealing device 18 can be flexibly bent or stretched and extends over the entire hollow space 14 in the exemplary embodiment illustrated in the figures. The first sealing element 16 of the sealing device 18 furthermore abuts on the switching element 12.

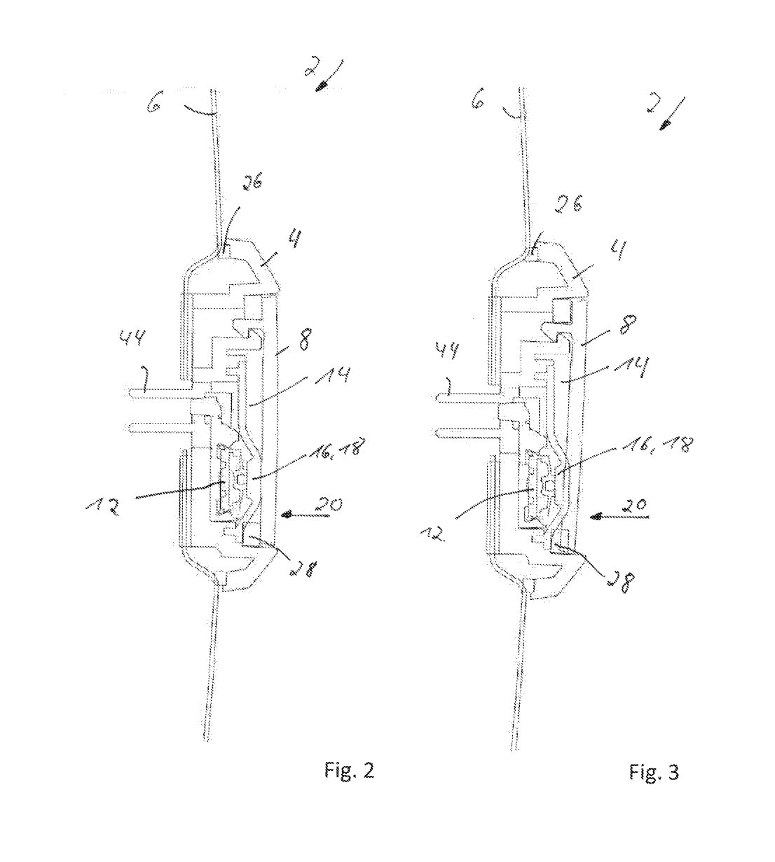

In order to automatically reset the second housing part 8 from an actuated position (FIG. 3) into a non-actuated home position (FIG. 2) after an actuation, the switch device 2 includes resetting element 22 that is realized in the form of leaf springs 24 in the exemplary embodiment illustrated in the figures.

In order to prevent the admission of dirt and moisture into the switch device 2, the sealing device 18 includes a second sealing element 26 that is arranged between the panel element 6 and the first housing part 4, as well as a third sealing element 28 that is arranged between the first housing part 4 and the second housing part 8. The second sealing element 26 and the third sealing element 28 are designed, in particular, in a frame-like fashion and have an outer contour that respectively corresponds to the outer edge of the first housing part or the second housing part.

In order to move and simultaneously fix the second housing part 8 relative to the first housing part 4, the switch device 2 includes a fixing unit 30 formed between the first housing part 4 and the second housing part 8. The fixing unit 30 includes two socket-like receptacles 38 on the first housing part 4, as well as pins designed corresponding to the socket-like receptacles 32 on the second housing part 8, in the exemplary embodiment illustrated in the figures. The pins 34 of the second housing part 8 can be clipped into the socket-like receptacles 32 of the first housing part 4. The socket-like receptacles 32 and the pins 34 are designed in a hinge-like fashion and include the rotational axis 10.

The switch device 2 furthermore includes a guide unit 36 that guides the motion of the second housing part 8 relative to the first housing part 4 and includes a recess 38 formed in the first housing part 4, as well as a projection 42 featuring a wedge-shaped section 40 on the second housing part 8. Due to the wedge-shaped section 40, the projection 42 engages behind the recess 38 when the non-actuated home position is reached.

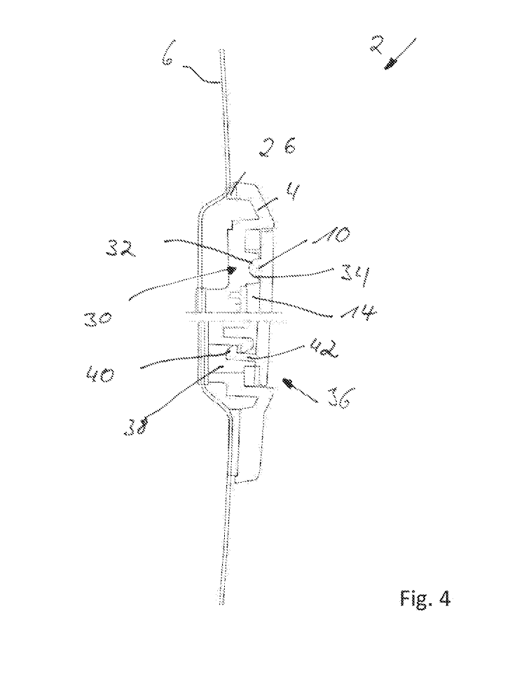

The function of the switch device 2 is described below with reference to FIGS. 2, 3 and 4. In order to actuate the switching element 12, the second housing part 8 is manually moved in the actuating direction 20. The moving direction corresponds to a rotatory motion about the rotational axis 10 that is spaced apart from the switching element 12. This triggers the switching element 12 such that an electrical signal is generated by means of electric contact 44. The motion of the second housing part 8 relative to the first housing part 4 is on the one hand guided by the hinge-like fixing unit 30 composed of the pins 34 and the socket-like receptacles 32 and on the other hand by the guide unit including the projection 42 on the second housing part 8 and the recess 38 in the first housing part 4.

After an actuation of the second housing part 8, the second housing part 8 is automatically reset by means of the resetting element 22 including the two leaf springs 24. Once the non-actuated home position is reached, the projection 42 featuring the wedge-shaped section 40 and the recess 38 of the guide unit 36 are in an engaged position.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A switch device for a panel element for a motor vehicle comprising:
a first housing part configured to be arranged in the panel element;
a second housing part that is rotatable relative to the first housing part about a rotational axis;
a switching element arranged in a hollow space formed between the first housing part and the second part, the switching element configured to abut extensively on one side of the first housing part, wherein said switching element can be actuated due to the motion of the second housing part relative to the first housing part along an actuating direction; and
a sealing device including a first sealing element at least on the side facing away from the first housing part and extensively overlapping the switching element in at least one of a transverse or oblique direction to the actuating direction.

17. The switch device according to claim 16, wherein the second housing part comprises at least one of a disk-shaped housing or a plate-shaped housing.

18. The switch device according to claim 16, wherein the first sealing element is configured to flexibly bend at least in the actuating direction of the switching element.

19. The switch device according to claim 18, wherein the first sealing element is arranged in and overlaps the hollow space in at least one of the transverse or oblique direction.

20. The switch device according to claim 16, wherein the first sealing element abuts the switching element.

21. The switch device according to claim 20, wherein the first sealing element is bonded on the switching element.

22. The switch device according to claim 16, further comprising a resetting element configured to bias at least the second housing part into a non-actuated home position.

23. The switch device according to claim 22, wherein the resetting element comprises a leaf spring positioned between the switching element and one of the second housing part or the first sealing element.

24. The switch device of claim 23 wherein the resetting element is arranged in a recess formed in the first housing part.

25. The switch device according to claim 16 further comprising a second sealing element peripherally arranged between the panel element and an outer edge of the first housing part.

26. The switch device according to claim 25 further comprising a third sealing element peripherally arranged between the first housing part and an outer edge of the second housing part.

27. The switch device according to claim 26, wherein the second sealing element includes a first frame surrounding the outer contour of the first housing part and the third sealing element includes a second frame surrounding the outer contour of the second housing part.

28. The switch device according to claim 16 further comprising a fixing unit formed between the first housing part and the second housing part configured to rotatably fix the second housing part on the first housing part, wherein said fixing unit include at least one socket-like receptacle and at least one pin corresponding to the at least one socket-like receptacle such that said pin can be clipped into the socket-like receptacle.

29. The switch device according to claim 28, wherein the fixing unit comprises at least two socket-like receptacles and at least two pins, wherein the fixing unit is configured in a hinge-like fashion and defines the rotational axis.

30. The switch device according to claim 29, wherein the rotational axis extends transversely to the actuating direction and is spaced apart from the switching element transverse to the actuating direction.

31. The switch device according to claim 16, further comprising a guide unit formed between the first housing part and the second housing part, the guide unit including a recess in the first housing part and a projection extending in the actuating direction and having a wedge-shaped section formed on the second housing part, wherein said projection slides into the recess during the actuation in the actuating direction such that movement in a direction opposite to the actuating direction is restricted by the wedge-shaped section that engages behind the recess in the non-actuated home position.

32. The switch device according to 31, wherein the first housing part, the socket-like receptacle and the recess of the guide unit comprise an injection-molded part.

33. The switch device (2) according to claim 16, wherein the switching element comprises a microswitch.

34. The switch device according to claim 16, further comprising an electric contact arranged on the first housing part on a side opposite the switching element, wherein the switching element cooperates with the electric contact such that an electrical connection is produced therebetween.

35. A motor vehicle with at least one switch device according to claim 16.
